(19) United States
(12) Patent Application Publication
(10) Pub. No.: US 2019/0207784 A1
(43) Pub. Date: Jul. 4, 2019

(54) ESTABLISHING A SECURE CONNECTION BETWEEN SEPARATED NETWORKS

(71) Applicant: CyberArk Software Ltd., Petach-Tikva (IL)

(72) Inventor: Evgeni Aizikovich, Petach-Tikva (IL)

(73) Assignee: CyberArk Software Ltd., Petach-Tikva (IL)

(21) Appl. No.: 15/861,262

(22) Filed: Jan. 3, 2018

(51) Int. Cl. H04L 12/46; G06F 9/455; H04L 29/06

(52) U.S. Cl. CPC H04L 12/4633; G06F 9/45558; G06F 2009/45562; G06F 2009/45595; H04L 63/029

(57) ABSTRACT

Disclosed embodiments include engaging in a control session between a tunneling control service located in a first network and a tunneling control agent located in a second network, identifying a request, from a requesting resource in the first network, to establish a secure remote connection with a target resource in the second network, the target resource having a network address in the second network, sending, from the tunneling control service in the first network to the tunneling control agent in the second network, a request to establish a reverse tunnel between the first network and the second network, transmitting a request for a reverse tunnel connection between a tunneling server in the first network and a tunneling agent in the second network, the tunneling agent being configured to redirect traffic from the reverse tunnel to the target resource at the network address in the second network, and transmitting data traffic from the requesting resource in the first network through the reverse tunnel to the tunneling agent, for redirection by the tunneling agent to the target resource.

### BACKGROUND

Accessing network resources (e.g., databases, servers, applications, etc.) located in an on-premises computer network of an organization, or in a cloud-based computer network, is often required for successful operation of mobile and cloud applications. One challenge with providing such access is that network resources located inside a private network often use a private Internet protocol (IP) address space and therefore are not accessible from the Internet. In addition, some organization firewall systems may restrict incoming connections, making it difficult to connect to devices located within an internal network from the outside. This technical challenge is particularly apparent when requesting or requiring access from an external network, like the Internet, to a network resource within a private network (either on-premises or cloud), on an on-demand or as-needed basis.

Some approaches may allow incoming connections on a specific port selected from a plurality of whitelisted IP addresses, and assigning a public IP address to the desired network resource. Other approaches may include Virtual Private Network (VPN), point-to-point, or point-to-site techniques that allow access to a particular network resource or to a particular site only. Notably, these approaches typically require a dedicated VPN device or predetermined IP addresses mapping, and thus are less flexible and agile in a dynamic network environment.

Other approaches may involve reverse tunneling for establishing a point-to-point TCP connection. Such approaches may rely on the common practice for organizations to allow outgoing TCP connections over a specific designated port (e.g., port 443) that is used to make the Internet accessible from the organization's private network. Nevertheless, reverse tunneling has drawbacks. Once a reverse tunnel is established, it typically cannot be redefined to access another machine. Additionally, while it often can support simple protocols, such as secure shell (SSH), it does not support more sophisticated types of protocols.

There is thus a need for technological solutions for providing a secure connection between separated networks. There is further a need for doing so dynamically in a changing network environment. Further, there is a need for providing such connections in network environments that use varying communications protocols, varying types of applications, and varying types of network resources.

### SUMMARY

The disclosed embodiments describe non-transitory computer readable media and methods for establishing a secure connection between resources in separated networks. For example, in an exemplary embodiment, there may be a non-transitory computer readable medium including instructions that, when executed by at least one processor, cause the at least one processor to perform operations for establishing a secure connection between resources in separated networks. The operations may comprise engaging in a control session between a tunneling control service located in a first network and a tunneling control agent located in a second network; identifying a request, from a requesting resource in the first network, to establish a secure remote connection with a target resource in the second network, the target resource having a network address in the second network; sending, from the tunneling control service in the first network to the tunneling control agent in the second network, a request to establish a reverse tunnel between the first network and the second network; transmitting a request for a reverse tunnel connection between a tunneling server in the first network and a tunneling agent in the second network, the tunneling agent being configured to redirect traffic from the reverse tunnel to the target resource at the network address in the second network; and transmitting data traffic from the requesting resource in the first network through the reverse tunnel to the tunneling agent, for redirection by the tunneling agent to the target resource.

According to a disclosed embodiment, the network address is unknown by and inaccessible to the requesting resource.

According to a disclosed embodiment, the request to establish the reverse tunnel between the first network and the second network is sent over the control session.

According to a disclosed embodiment, the tunneling agent is an instance that is generated on demand by the tunneling control agent.

According to a disclosed embodiment, the operations further comprise receiving, from the tunneling agent, a specified port number associated with the target resource.

According to a disclosed embodiment, the transmitting of data traffic from the requesting resource in the first network through the reverse tunnel to the tunneling agent includes identifying the specified port number for the target resource.

According to a disclosed embodiment, the transmitting of data traffic from the requesting resource in the first network through the reverse tunnel to the tunneling agent includes concatenating an IP address of the tunneling agent with the specified port number for the target resource.

According to a disclosed embodiment, the specified port number is unique to the reverse tunnel.

According to a disclosed embodiment, the specified port number is dynamically allocated by the tunneling agent in response to the request for the reverse tunnel connection.

According to a disclosed embodiment, the reverse tunnel is transparent to the target resource.

According to a disclosed embodiment, the operations further comprise terminating the reverse tunnel upon conclusion of the secure remote connection with the target resource.

According to a disclosed embodiment, the tunneling control service located in the first network is configured to communicate with a plurality of different tunneling control agents located in a plurality of different networks.

According to a disclosed embodiment, the requesting resource has a software agent running locally on the requesting resource, the software agent being configured to monitor data traffic from the requesting resource and intercept data traffic that is destined for the target resource.

According to a disclosed embodiment, the software agent is further configured to determine that the reverse tunnel has been established between the tunneling server in the first network and the tunneling agent in the second network; determine a specified port number associated with the target resource; and redirect the data traffic from the requesting resource to the target resource via the reverse tunnel.

According to a disclosed embodiment, the software agent is configured to determine that no reverse tunnel is currently established between the tunneling server in the first network and the tunneling agent in the second network; send a request to the tunneling control agent to establish a reverse tunnel; determine a specified port number associated with the target resource; and redirect the data traffic from the requesting resource to the target resource via the reverse tunnel.

According to another disclosed embodiment, a method may be implemented for establishing a secure connection between resources in separated networks. The method may comprise engaging in a control session between a tunneling control service located in a first network and a tunneling control agent located in a second network; identifying a request, from a requesting resource in the first network, to establish a secure remote connection with a target resource in the second network, the target resource having a network address in the second network; sending, from the tunneling control service in the first network to the tunneling control agent in the second network, a request to establish a reverse tunnel between the first network and the second network; transmitting a request for a reverse tunnel connection between a tunneling server in the first network and a tunneling agent in the second network, the tunneling agent being configured to redirect traffic from the reverse tunnel to the target resource at the network address in the second network; and transmitting data traffic from the requesting resource in the first network through the reverse tunnel to the tunneling agent, for redirection by the tunneling agent to the target resource.

According to another disclosed embodiment, the tunneling control agent and tunneling agent are a single integrated resource.

According to another disclosed embodiment, at the time of identifying the request to establish the secure remote connection with the target resource in the second network, the target resource has not yet been instantiated.

According to another disclosed embodiment, the method may further comprise instantiating the target resource as a virtual machine instance.

According to another disclosed embodiment, the method may further comprise instantiating the target resource as a container instance.

According to another disclosed embodiment, the method may further comprise establishing a plurality of reverse tunnels between the tunneling server in the first network and a plurality of tunneling agents in the second network, each of the plurality of tunneling agents being configured to redirect traffic from their respective reverse tunnel to different target resources in the second network.

According to another disclosed embodiment, each respective reverse tunnel has a different port number, and each port number is provided to the tunneling server.

According to another disclosed embodiment, the network address is specified by the requesting resource in the request to establish the secure remote connection with the target resource.

According to another disclosed embodiment, the request to establish the reverse tunnel between the first network and the second network is sent over the control session.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an example system in accordance with disclosed embodiments.

FIG. 2 is a block diagram of another example system in accordance with disclosed embodiments.

FIG. 3 is a block diagram of a further example system in accordance with disclosed embodiments.

FIG. 4 is a block diagram of an additional example system in accordance with disclosed embodiments.

FIG. 5 is a flowchart of an example method for establishing a secure connection between resources in separated networks in accordance with disclosed embodiments.

FIG. 6 is a flowchart of an example method for dynamically allocating a specified port number in accordance with disclosed embodiments.

FIG. 7 is a flowchart of an example method for determining whether to terminate a reverse tunnel in accordance with disclosed embodiments.

FIG. 8 is a flowchart of an example method for determining whether to intercept data traffic in accordance with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

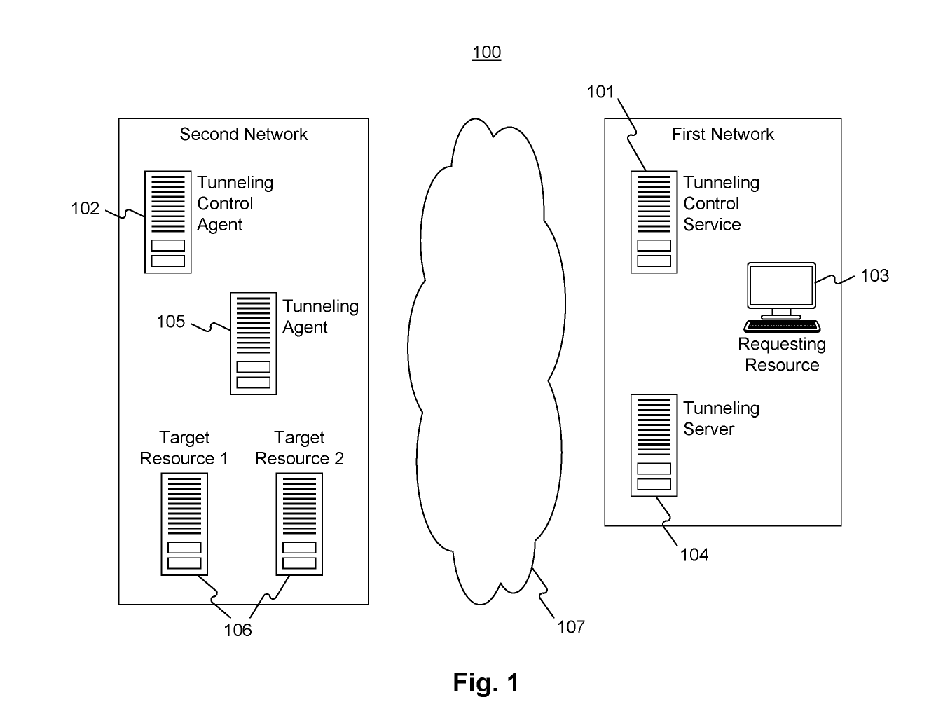

FIG. 1 is a block diagram of an example system in accordance with disclosed embodiments. As shown, system 100 includes a tunneling control service 101 in a first network, which is configured for communication with a tunneling control agent 102 in a second network. The first and second networks may communicate via network 107, which may include the Internet, a local area network (LAN), a wireless local area network (WLAN), a wide area network (WAN), a cellular communication network, or any other Internet Protocol (IP) based communication network and the like. In some embodiments, network 107 may be based on public cloud infrastructure, private cloud infrastructure, hybrid public/private cloud infrastructure, or no cloud infrastructure. The first and second networks may both be part of network 107, one of them may be part of network 107, or both may be part of separate networks. In some embodiments, the second network may have a firewall that initially receives and screens incoming communications from the first network.

Tunneling control service 101 and tunneling control agent 102 may participate in a control session, which may be initiated by either tunneling control service 101 or tunneling control agent 102. As disclosed herein, the control session may be established in accordance with a variety of protocols, such as Secure Shell (SSH), hypertext transfer protocol (HTTP), Internet Control Message Protocol (ICMP), General Packet Radio Service (GPRS) Tunneling Protocol (GTP), and others, including variants or extensions thereof.

As described further below, the control session may be established before, or as part of, a process of establishing a reverse tunnel between resources in two different networks or within the same network. The reverse tunnel may likewise be established using protocols such as SSH, HTTP, ICMP, GTP, and others, including variants or extensions thereof. Once the control session is established, the tunneling control service 101 and tunneling control agent 102 can determine whether a reverse tunnel between the first and second networks has been requested, or has been already established. Further, once the control session has been established, a reverse tunnel between the first and second networks may be established, as discussed below.

As illustrated in FIG. 1, the first network of system 100 includes a requesting resource 103. Requesting resource 103 may be a computing device, identity, or account, which may include, for example, a desktop computer, a laptop computer, a smartphone, a tablet, a personal digital assistant, an enterprise digital assistant, a server, a cloud-computing virtual machine or container, a smart card, a smart watch, a smart band, a smart headphone, computer-embedded clothing, a car-computer and other in-vehicle computer equipment, an Internet-of-Things (IoT) device, or other devices with data processing and network connectivity capabilities. In some embodiments, requesting resource 103 may include a user identity established according to a particular local operating system (e.g., Microsoft Windows®, Mac OS®, UNIX, etc.) or a particular security service. Alternatively or additionally, a requesting resource 103 may include a network identity established according to a network operating system (e.g., a Microsoft® network operating system, a Cisco® network operating system, a Dell® network operating system, a Linux network operating system, etc.) or a network security protocol or service. Requesting resource 103 may also be an instance of a virtual machine or container running in a cloud computing environment. Furthermore, requesting resource 103 may include a token used to identify a particular computing resource, person, account, virtual machine, container, or other entities accessing a computer or network. Requesting resource 103 may have an associated Internet browser (e.g., Microsoft Internet Explorer®, Google Chrome®, Apple Safari®, Mozilla Firefox®, etc.) enabled to support communications with the second network or other networks. Further, requesting resource 103 may have locally running applications or remotely accessible applications, which can be controlled by requesting resource 103 to access the second network or other networks.

As discussed further below, requesting resource 103 may request access to one or more target resources 106 in the second network. Target resources 106 may be IP-addressable, MAC-addressable, or otherwise network-accessible resources such as servers, databases, network-hosted memory, network-hosted applications, etc. For example, the requesting resource 103 may be a mobile application executing on a smartphone and the target resource 106 may be a cloud-hosted customer relations management (CRM) system that is accessible to the mobile application. Further, the requesting resource 103 may be a local Microsoft Windows® account of a payroll administrator in an organization and a target resource 106 may be payroll database within the organization. Alternatively, the requesting resource 103 may be an IoT device, such as a network-enabled home appliance, and the target resource 106 may be a server to which the IoT device reports usage or maintenance data. Numerous other alternatives for the requesting resource 103 and target resources 106 are possible as well. In some embodiments, requesting resource 103 may run on the same machine or physical device as tunneling control service 101 and tunneling server 104. In such embodiments, tunneling control service 101 or tunneling server 104 may run transparently to an operating system or user of requesting resource 103. Alternatively, tunneling control service 101 and tunneling server 104 may run on a physically separate machine or device from requesting resource 103.

Target resources 106 may or may not be access-restricted. A target resource 106 is access-restricted when access to that resource is limited by software-based restrictions (e.g., instructions carried out by a processor of target resource 106, tunneling agent 105, or tunneling control agent 102). Access may be restricted, for example, through a requirement that some requesting resources 103 must supply, or have supplied on their behalf, authentication or authorization information (e.g., user credentials, usernames, passwords, SSH keys, symmetric (e.g., public/private) keys, or other types of cryptographic data or privileged access tokens) that is verified before access to the target resource 106 is permitted. The verification may occur at target resource 106, tunneling agent 105, or tunneling control agent 102, or elsewhere (e.g., through an external credential management system, such as a CyberArk® vault).

As shown in FIG. 1, the first network further includes a tunneling server 104 and the second network further includes a tunneling agent 105. As discussed further below, tunneling server 104 and tunneling agent 105 may be configured to establish a reverse tunnel between the first and second networks. The reverse tunnel may be initiated by either tunneling server 104 or tunneling agent 105, for example, by sending a request for a reverse tunnel connection. Tunneling server 104 in the first network may be configured to route data traffic to and from requesting resource 103 through the reverse tunnel. Tunneling agent 105, in turn, may be configured to route data traffic to and from target resources 106. In some embodiments, tunneling server 104 may run on the same machine or physical device as requesting resource 103. For example, tunneling server 104 may be configured as an agent, driver, or other application running locally on requesting resource 103. In such embodiments, tunneling server 104 may or may not operate transparently to an operating system or user of requesting resource 103. Alternatively, tunneling server 104 and requesting resource 103 may be physically separate machines or devices. Similarly, tunneling agent 105 may run on the same machine or device, or a different machine or device, as tunneling control agent 102 or target resources 106.

With respect to the components of FIG. 1, each of tunneling control service 101, tunneling control agent 102, requesting resource 103, tunneling server 104, tunneling agent 105, and target resources 106 may include at least one processor and memory storing specialized instructions. The processor may include one or more dedicated processing units, application-specific integrated circuits (ASICs), field-programmable gate arrays (FPGAs), or various other types of processors or processing units coupled with at least one non-transitory processor-readable memory configured for storing processor-executable code. When the processor-executable code is executed by the processor, the processor may carry out instructions in response to various types of requests received via network 107 and/or originating at the respective devices or components themselves. For instance, a processor may carry out instructions to identify engage in a control session, to identify a request for a secure remote connection to a target resource, to send a request to establish a reverse tunnel, to transmit a request for a reverse tunnel connection, or to transmit data traffic.

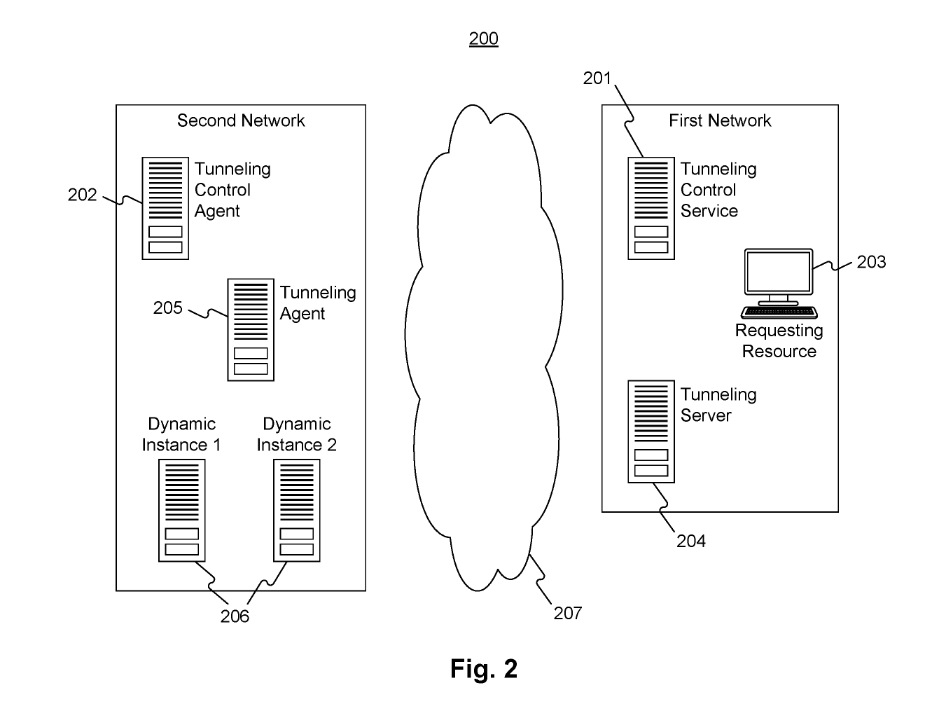

FIG. 2 is a block diagram of another example system 200 in accordance with disclosed embodiments. As shown, system 200 includes a tunneling control service 201, tunneling control agent 202, requesting resource 203, tunneling server 204, tunneling agent 205, and network 207, which may be similar to tunneling control service 101, tunneling control agent 102, requesting resource 103, tunneling server 104, tunneling agent 105, and network 107 as shown in FIG. 1. In addition, system 200 includes cloud-based dynamic instances 206 of target resources. Cloud-based instances 206 may be dynamically spun up or spun down in a public, private, or hybrid cloud environment, which may or may not include tunneling control agent 202 and tunneling agent 205. The cloud environment may be hosted by a cloud provider, such as Amazon Web Services™, Microsoft Azure™, Cloudify™, etc. Cloud-based instances 206 may be, for example, instances of virtual machines, docker containers, or other cloud-based instances of network resources. As discussed above, requesting resource 203 may request access to such cloud-based instances 206, and tunneling agent 205 may participate in creating a reverse tunnel to allow for such access.

In some embodiments, as discussed below, cloud-based instances 206 may or may not yet exist at the time requesting resource 203 makes a request to establish secure communications with them. For example, in some embodiments a cloud-based instance 206 may be spun up on-demand after requesting resource 203 issues a request to communicate with a specific resource or application in the second network. In some embodiments cloud-based instances 206 may be spun up on-demand by tunneling agent 205 or by another cloud orchestrating system.

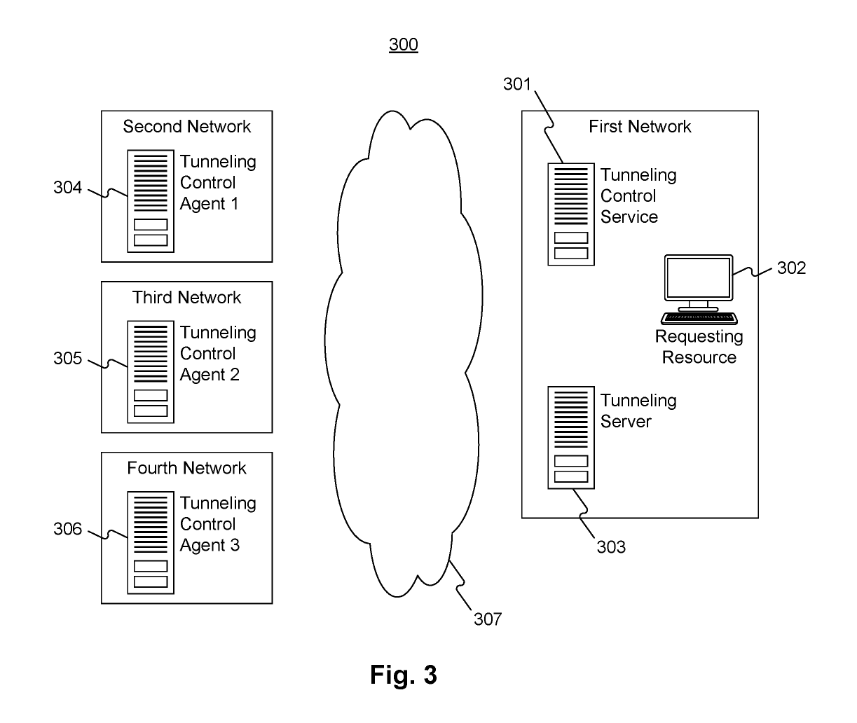

FIG. 3 is a block diagram of a further example system 300 in accordance with disclosed embodiments. As shown, system 300 includes a tunneling control service 301, requesting resource 302, tunneling server 303, and network 307, each of which may be similar to the components described above in FIGS. 1 and 2. In addition, FIG. 3 illustrates a first tunneling control agent 304 in a second network, a second tunneling control agent 305 in a third network, and a third tunneling control agent 306 in a fourth network. In accordance with such embodiments, tunneling control service 301 may be configured to engage in a control session with a tunneling control agent 304/305/306 in each of the second, third, and fourth networks, or with one centralized tunneling control agent, in order to manage the creation of reverse tunnels between the first network and each of the second, third, and fourth networks. Further, tunneling server 303 may be configured to establish such reverse tunnels with first tunneling control agent 304, second tunneling control agent 305, and third tunneling control agent 306. Based on such reverse tunnels, requesting resource 302 may securely exchange data traffic with a target resource in each of the second, third, and fourth networks.

In some embodiments, the second, third, and fourth networks of system 300 may all be part of the same enterprise network (e.g., cloud or on-premises) or may be in separate networks. As an example, the first network may be a remotely-hosted application network of an enterprise, the second network may be a human resources network of the enterprise, and the third network may be a source code versioning network of the enterprise. Each of the second, third, and fourth networks may be accessed from requesting resource 302 via a reverse tunnel provisioned by tunneling control agents 304, 305, and 306. Alternatively, the second network may be maintained by an enterprise (e.g., a document storage network), while the third and fourth networks are maintained by unrelated third-parties (e.g., Facebook™ and Dropbox™) In such embodiments, tunneling control agents 304, 305, and 306 may be separately provisioned and managed by those different entities.

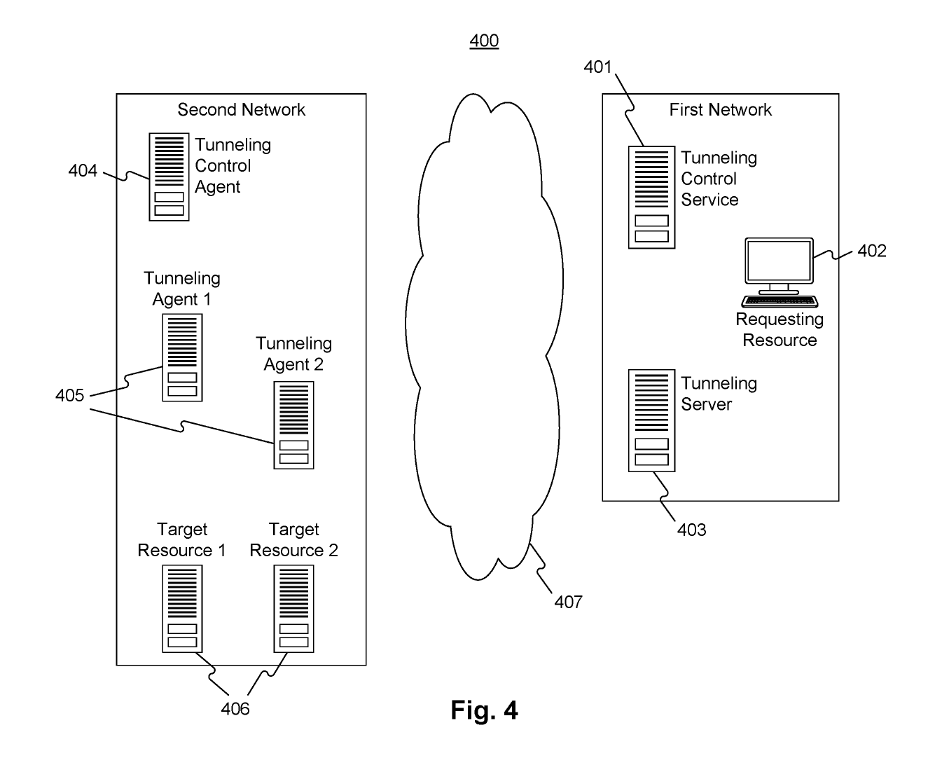

FIG. 4 is a block diagram of an additional example system in accordance with disclosed embodiments. As shown, system 400 includes a tunneling control service 401, requesting resource 402, tunneling server 403, tunneling control agent 404, and network 407, each of which may be similar to the components described above in FIGS. 1, 2, and 3.

Further, system 400 includes a plurality of tunneling agents 405 corresponding to a plurality of target resources 406. In some embodiments, tunneling agents 405 may be dedicated for the purpose of establishing reverse tunnels with their respective target resources 406. Such tunneling agents 405 may be integrated into the same physical machine or device as target resources 406, or may be physically separate. In other embodiments, tunneling agents 405 may be cloud-based resources that are spun up on-demand. Similarly, as discussed above, target resources 406 may also be cloud-based resources that are spun up on-demand. For example, if requesting resource 402 transmits a request for secure communications with a particular application or other resource in the second network, a tunneling agent 405 may be spun up on-demand together with a corresponding target resource 406. Tunneling agents 405 and target resources 406 may be spun up by tunneling control agent 404 or by another cloud orchestration system, as discussed above.

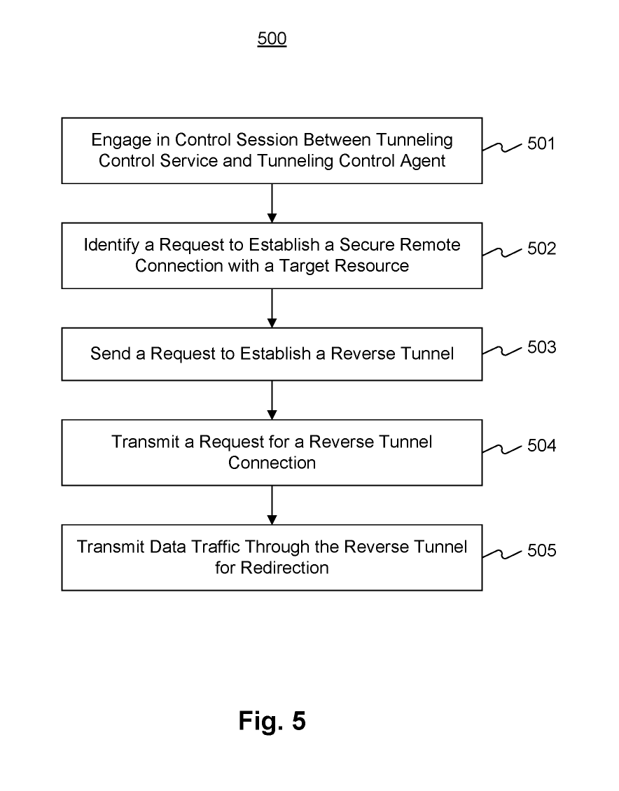

FIG. 5 is a flowchart illustrating an example method 500 for establishing a secure connection between resources in separated networks in accordance with disclosed embodiments. Process 500 may be implemented in the systems of FIGS. 1-4, as discussed above, as well as in variations or combinations of such systems.

Process 500 may include a step 501 of engaging in a control session between a tunneling control service located in a first network and a tunneling control agent located in a second network. For example, with respect to system 100 shown in FIG. 1, tunneling control service 101 in the first network may engage in a control session with tunneling control agent 102 in the second network. In some embodiments, the control session between tunneling control service 101 and tunneling control agent 102 may be permanent or semi-permanent. For example, the control session may be established irrespective of any request from resources in the first network to communicate with resources in the second network, and may be preexisting at the time of any such request. In such embodiments, the control session may be established upon initialization of system 100. In other embodiments, the control session may be established in response to a request from requesting resource 103 to securely communicate with a target resource 106 in the second network. In such embodiments, the control session may be provisioned specifically for the purpose of handling a discrete control session between tunneling control service 101 and tunneling control agent 102, and may be terminated after it becomes inactive. According to some embodiments, by contrast, there may be multiple control sessions between tunneling control service 101 and tunneling control agent 102, or between tunneling control service 101 and tunneling control agents in multiple other networks (e.g., as described with respect to FIG. 3, above).

Process 500 may include a step 502 of identifying a request, from a requesting resource in the first network, to establish a secure remote connection with a target resource in the second network. With respect to FIG. 1, for example, requesting resource 103 may transmit a request for a secure remote connection with target resource 106. Target resource 106 may have a network address (e.g., IP address or MAC address) in the second network that is known to requesting resource 103, known to tunneling control service 101, or known to tunneling server 104. The request may be received by one or multiple of tunneling control service 101, tunneling server 104, tunneling control agent 102, or tunneling agent 105.

In some embodiments, the network address of target resource 106 may be a private address that is not accessible from the Internet. For example, target resource 106 may have a private IP address of 10.0.0.1. In that case, requesting resource 103 may issue to tunneling control service 101 a request for a connection to the private IP address 10.0.0.1. In some embodiments, the second network may have a firewall that prevents target resource 106 from being publicly addressable via a public IP address. Further, such a firewall may be configured to only allow communications through a designated port (e.g., port 443). Nevertheless, in other embodiments there is no firewall in the second network, or at least no firewall configured to handle communications from requesting resource 103 or tunneling control service 101.

Process 500 may include a step 503 of sending, from the tunneling control service in the first network to the tunneling control agent in the second network, a request to establish a reverse tunnel between the first network and the second network. With reference to FIG. 1, for example, this may involve tunneling control service 101 sending to tunneling control agent 102 a request to establish a reverse tunnel between the first network and second network. In some embodiments, as discussed above, it may be determined that a reverse tunnel is already established. In other embodiments, no reverse tunnel is established and one will potentially be established.

In some embodiments, the request to establish the reverse tunnel may involve tunneling control service 101 redirecting the request from requesting resource 103 to tunneling control agent 102 or to tunneling agent 105. For example, the request from requesting resource 103 may be redirected based on a uniform resource locator (URL) redirect, such as an HTTP redirect. The redirect message may be sent over the open control session between tunneling control service 101 and tunneling control agent 102, or may be directly from tunneling control service 101 to tunneling agent 105. In some embodiments, tunneling control service 101 may provide the network address of a tunneling server in the first network (e.g., tunneling server 104, in FIG. 1) in the redirect or separately to tunneling control agent 102 or tunneling agent 105. For example, if the IP address of tunneling server 104 is 57.124.95.22, the redirect or a separate message from tunneling control service 101 may provide that IP address. In other embodiments, tunneling control service 101 provides the IP address of tunneling server 104 to tunneling control agent 102 or tunneling agent 105 without a redirect.

Process 500 may include a step 504 of transmitting a request for a reverse tunnel connection between a tunneling server in the first network and a tunneling agent in the second network. For example, with reference to FIG. 1, tunneling control service 101 or another component (e.g., tunneling control agent 102 or tunneling agent 105) may transmit a request for a reverse tunneling connection between tunneling agent 105 and tunneling server 104. In some embodiments, tunneling agent 105 may be configured to redirect traffic from the reverse tunnel to target resource 106 at a network address in the second network. For example, tunneling agent 105 may be configured to redirect traffic from the reverse tunnel based on the IP address for target resource 106 (e.g., 10.0.0.1). Thus, when tunneling agent 105 receives data traffic over the reverse tunnel (e.g., from requesting resource 103 or tunneling server 104), it may be redirected to target resource 106.

In some embodiments, establishing the reverse tunnel between tunneling agent 105 and tunneling server 104 may involve invoking a new instance of tunneling agent 105. For example, as discussed above, this may involve spinning up tunneling agent 105 in a cloud environment as a new virtual machine or docker container. In such embodiments, tunneling agent 105 may or may not already be spun up at the time of the request to establish the reverse tunnel connection between tunneling agent 105 and tunneling server 104. In other embodiments, tunneling agent 105 is a dedicated application that is already running when the request is received. For example, tunneling agent 105 may operate permanently or semi-permanently and function to establish reverse tunnels with tunneling server 104 on an as-needed basis.

When tunneling agent 105 is spun up or otherwise invoked, it may have a parameter based on a network address of tunneling server 104. For instance, in the above example tunneling server 104 had an IP address of 57.124.95.22. Accordingly, tunneling agent 105 may have a parameter of “connect to 57.124.95.22 and redirect to 10.0.0.1.” Based on this parameter, tunneling agent 105 may engage in a reverse tunnel connection with tunneling server 104, and may be configured to redirect traffic to target resource 106. Further, in some embodiments establishing the reverse tunnel may involve assigning a specific port number (e.g., port 1234) for the reverse tunnel. The port number may be unique to the target resource 106. For example, in an embodiment with multiple reverse tunnels to multiple target resources 106, each reverse tunnel may use a different unique port for each target resource 106. The port number associated with a particular target resource 106 may be communicated back to the first network (e.g., to tunneling server 104 or requesting resource 103) for use in future communications from requesting resource 103 to target resource 106 over the reverse tunnel.

Process 500 may also include a step 505 of transmitting data traffic from the requesting resource in the first network through the reverse tunnel to the tunneling agent, for redirection by the tunneling agent to the target resource. With reference to FIG. 1, for example, data traffic may be transmitted through the reverse tunnel between requesting resource 103 and target resource 106. When data traffic from requesting resource 103 is received at tunneling agent 105, for instance, it may be redirected to target resource 106. In the above example where tunneling agent 105 has a parameter of “connect to 57.124.95.22 and redirect to 10.0.0.1,” tunneling agent 105 may determine that when it receives data traffic from requesting resource 103 (via tunneling server 104, which has an IP address of 57.124.95.22), it will redirect the traffic to target resource 106 at IP address 10.0.0.1. Similarly, tunneling server 104 may have a corresponding redirection parameter. For instance, if the IP address of tunneling agent 105 is 58.125.96.23 and the IP address of requesting resource 103 is 59.126.97.24, tunneling server 104 may have a parameter of “connect to 58.125.96.23 and redirect to 59.126.97.24.” Alternatively, tunneling server 104 may forward data traffic from target resource 106 to requesting resource 103 without such a redirect.

In some embodiments, requesting resource 103 may communicate data traffic over the reverse tunnel to and from target resource 106 by concatenating the IP address of tunneling server 104 with the port number associated with the target resource 106. For example, if the IP address of tunneling server 104 is 57.124.95.22 and the port associated with target resource 106 is 1234, requesting resource 103 may transmit data traffic by sending communications to tunneling server 104 with the concatenated IP address 57.124.95.22:1234. Similarly, tunneling server 104 may concatenate the IP address of tunneling agent 105 with the port number associated with target resource 106. Thus, if the IP address of tunneling agent 105 is 58.125.96.23 and the port associated with target resource 106 is 1234, tunneling agent 105 may transmit communications to the concatenated IP address 58.125.96.23:1234. As discussed above, in some embodiments tunneling server 104 may engage in reverse tunnels with multiple different tunneling agents 105 corresponding to multiple different target resources 106. In such embodiments, each of the different target resources 106 may have a unique port number, which may be concatenated with the IP addresses of the different target resources 106 themselves or with the IP addresses of the different tunneling agents 105. In this way, even if there is only a single IP address of tunneling server 104, requesting resources 103 may specify a particular port number, and hence a particular target resource 106, in requests to tunneling server 104. Similarly, even if there is only a single IP address of tunneling agent 105, communications may specify a particular port number of a particular target resource 106.

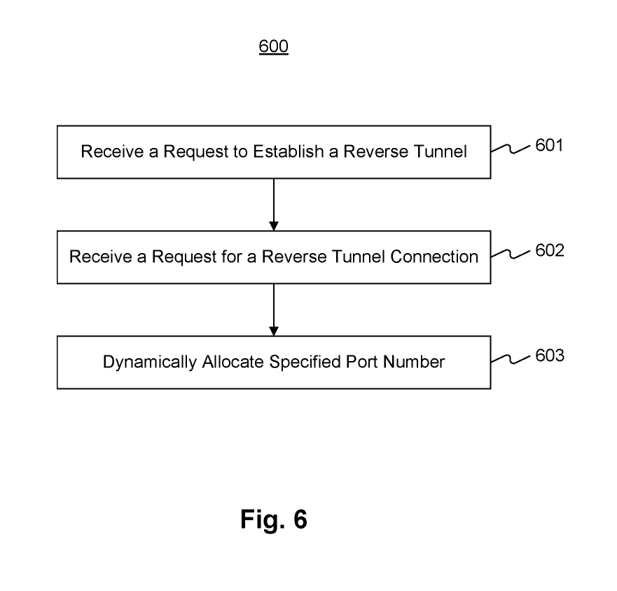

FIG. 6 is a flowchart illustrating an example method 600 for dynamically allocating port numbers in accordance with disclosed embodiments. Process 600 may be implemented in the systems of FIGS. 1-4, or as part of process 500 from FIG. 5, as discussed above, as well as in variations or combinations of such systems and processes. For example, process 600 may be performed by tunneling control agent 102 or tunneling agent 105 in FIG. 1.

Process 600 may include a step 601 of receiving a request to establish a reverse tunnel. In some embodiments, step 601 may be similar to, or may be part of, steps 502 or 503 of process 500, described above in connection with FIG. 5. Further, process 600 may include a step 602, which may be similar to, or may be part of, step 504 of process 500, as described above in relation to FIG. 5.

Further, process 600 may include a step 603 of dynamically allocating a specified port number. As discussed above, in some embodiments a tunneling agent (e.g., tunneling agent 105 in FIG. 1) may be responsible for allocating and managing port numbers for particular target resources (e.g., target resources 106 in FIG. 1). For example, tunneling agent 105 may have predefined port numbers stored in memory that correspond to individual target resources 106. Alternatively, tunneling agent 105 may dynamically create and assign new port numbers as needed to handle reverse tunnels with tunneling server 104. Tunneling agent 105 may dynamically allocate port numbers based on availability of ports or target resources 106, based on a network policy accounting for security or load parameters, or based on other determinations. As discussed above, port numbers for target resources 106 may be assigned as part of a process of spinning up instances of target resources 106. Further, once specified port numbers are assigned for target resources 106, the port numbers may be communicated to tunneling server 104 or requesting resource 103 for use in directing communications from requesting resource 103 to the appropriate target resource 106 via reverse tunnels.

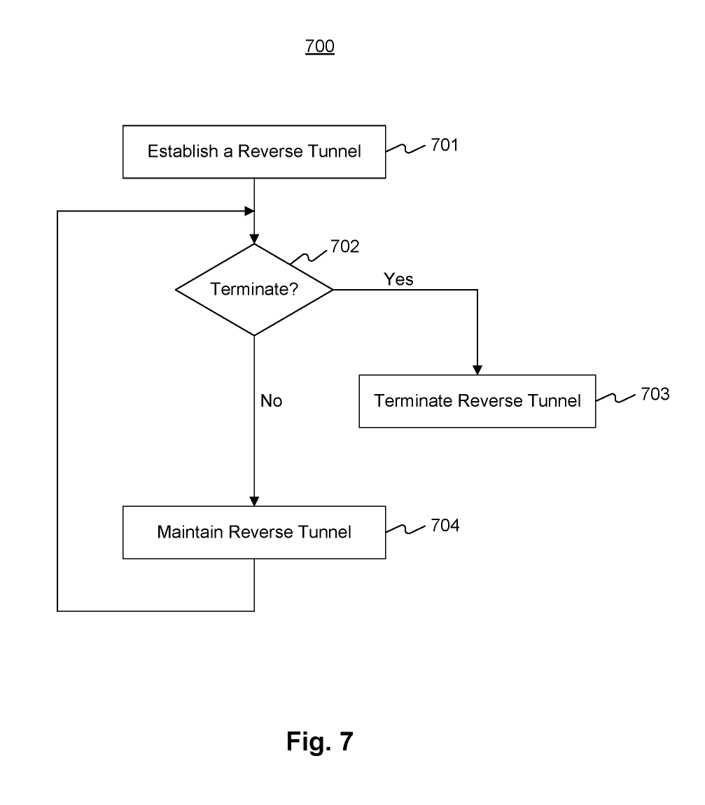

FIG. 7 is a flowchart illustrating an example method 700 for determining whether to terminate reverse tunnels in accordance with disclosed embodiments. Process 700 may be implemented in the systems of FIGS. 1-4, or as part of processes 500 or 600 from FIGS. 5 and 6, as discussed above, as well as in variations or combinations of such systems and processes. In some embodiments, for example, process 700 may be performed by tunneling control agent 102 or tunneling agent 105 of FIG. 1.

Process 700 may include a step 701 of establishing a reverse tunnel. As discussed above in connection with FIG. 1, a reverse tunnel may be established between tunneling agent 105 and tunneling server 104. Once the reverse tunnel is established, requesting resource 103 and target resource 106 may engage in secure communications through the reverse tunnel.

Process 700 may also include a step 702 of determining whether to terminate the reverse tunnel. This decision may be made in various ways. For example, step 702 may involve observing communications over the reverse tunnel and determining whether a period of inactivity has been detected. If a period of inactivity meeting a threshold of time (e.g., five seconds, five minutes, five hours, etc.) is detected, a decision may be made to terminate the reverse tunnel in step 703. Similarly, step 702 may involve determining whether potentially malicious activity is occurring over the reverse tunnel. For example, if a network security service determines that requesting resource 103 or target resource 106 have failed an authentication or authorization challenge, or have engaged in suspicious or fraudulent activity in the network, their ability to participate in the reverse tunnel may be terminated. The result of that determination may likewise involve terminating the reverse tunnel in step 703. As another example, step 702 may involve determining whether an account associated with requesting resource 103 or target resource 106 becomes logged out or inactive. If such an account logs out or becomes inactive, the result may similarly be to terminate the reverse tunnel in step 703. As a further example, if the secure connection between requesting resource 103 and target resource is terminated or ended, a decision may be made to terminate the reverse tunnel. Various other conditions and determinations may be performed as part of step 702. If, however, if is determined in step 702 that the reverse tunnel should not be terminated, then a decision in step 704 may be made to maintain the reverse tunnel. In such case, process 700 may cycle back (immediately, with a delay, or periodically) to step 702 to determine whether to terminate the reverse tunnel.

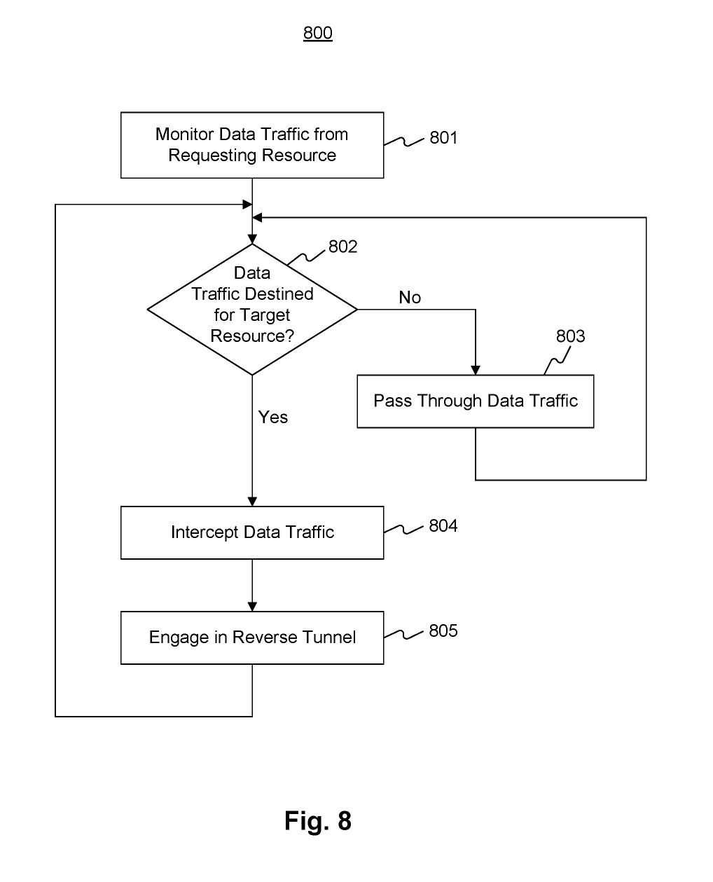

FIG. 8 is a flowchart illustrating an example method 800 for determining whether to intercept data traffic in accordance with disclosed embodiments. Process 800 may be implemented in the systems of FIGS. 1-4, or as part of processes 500, 600, and 700 from FIGS. 5, 6, and 7 as discussed above, as well as in variations or combinations of such systems and processes. In some embodiments, for example, process 800 may be performed by requesting resource 103 or tunneling server 104 of FIG. 1 or by a driver, agent, or other application running on requesting resource 103 or tunneling server 104. Further, as discussed above, in some embodiments tunneling server 104 may be part of the driver, agent, or other application running on requesting resource 103.

Process 800 may include a step 801 of monitoring data traffic from a requesting resources. As discussed above in connection with FIG. 1, this may involve monitoring data traffic from requesting resource 103. In varying embodiments, some, all, or none of the data traffic from requesting resource 103 may be addressed for a reverse tunnel in the second network. Accordingly, the monitoring in step 801 may involve analyzing the network address (e.g., IP address, MAC address, etc.) of communications from requesting resource 103. Further, as discussed above, such network addresses may or may not be concatenated with a port number associated with target resource 106.

Process 800 may include a step 802 of determining whether the data traffic from requesting resource 103 is destined for a target resource 106. For example, if data traffic from requesting resource 103 has the network address of tunneling server 104 or tunneling agent 105, it may be determined that the data traffic is destined for a target resource 106. Further, if the network address specifies a port number, the port number may further specify what particular tunneling agent 105 or target resource 106 it is addressed to.

Process 800 may include a step 803 of passing through data traffic based on the decision in step 802. For example, if step 802 determines that data packets sent from requesting resource 103 are not destined for a target resource 106, they may be passed through the driver, agent, or other application and allowed to pass to their intended destination. This may occur, for example, if requesting resource 103 is attempting to communicate with a network resource that is not in the second network and for which no reverse tunnel is provided. In that event, the data traffic is not intercepted, but instead is allowed to pass through the first network (e.g., through a network gateway) to its intended destination. When data traffic is passed through in step 803, the pass-through may be transparent to an operating system or user of requesting resource 103.

Process 800 may include a step 804 of intercepting data traffic from requesting resource 103 if it is determined that the data traffic is destined for a target resource 106. As discussed above, this may occur if the network address of the data packets from requesting resource 103 includes the network address of tunneling server 104 or tunneling agent 105, with or without a concatenated port number associated with target resource 106. In some embodiments, the driver, agent, or application on requesting resource may be programmed to know the address of tunneling server 104, tunneling agent 105, or target resource 106, so that it can determine if packets from requesting resource 103 are intended for a reverse tunnel. If it is determined that the data traffic is destined for target resource 106, the driver, agent, or other application may intercept the data traffic and route it through the reverse tunnel to the second network, as described above. In this way, the driver, agent, or other application may intercept the data traffic and ensure that it is transmitted through the reverse tunnel to tunneling agent 105, for redirection to target resource 106. When data traffic is intercepted in step 804, the pass-through may be transparent to an operating system or user of requesting resource 103.

Process 800 may also include a step 805 of engaging in a reverse tunnel. For example, if it is determined that no reverse tunnel has been established, then a process (e.g., process 500 of FIG. 5) may be performed to establish a reverse tunnel. Alternatively, if it is determined that a reverse tunnel is already established for communications between requesting resource 103 and target resource 106, then a decision may be made to use the reverse tunnel for communications between requesting resource 103 and target resource 106. As discussed above, this may involve tunneling server 104 routing the data traffic to tunneling agent 105, for redirection to the appropriate target resource 106.

Consistent with the above embodiments, numerous different types of use cases are envisioned. As an example, an organization may have an on-premises legacy network including resources such as a CRM server. The organization may choose to expose the CRM server to a remote mobile application for remote access (e.g., uploading, downloading, or modifying customer relations data and files). In that event, the organization will need a way to allow secure connections from the remote mobile application (e.g., running on smartphones) to access the CRM server. In accordance with the above embodiments, the smartphone could run a driver, agent, or other application that causes communication requests from the remote mobile application to be sent (e.g., intercepted and transmitted) to the legacy network that maintains the CRM server. The legacy network could include a tunneling agent that facilitates a reverse tunnel between the CRM server and the remote mobile application.

As another example, an organization may rely on cloud computing to perform complex calculations. For example, an organization have the need to perform a computation-intensive data-mining or artificial intelligence algorithm. In that case, a requesting computer that is requesting the calculation may seek to access a cloud environment where a virtual machine or container is spun up to perform the calculation. In accordance with above embodiments, the requesting computer may make a request for a connection to the cloud environment. Based on a control session established between a tunneling control service in the requesting computer's environment and a tunneling control agent in the cloud environment, a decision may be made to dynamically spin up the virtual machine or container to perform the calculation. In addition, a tunneling agent in the cloud environment may also be spun up, which will establish a reverse tunnel to a tunneling server in the requesting computer's environment. The requesting computer can then perform the calculation on the virtual machine or container based on instructions or data sent through the reverse tunnel to the cloud environment.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of the these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A non-transitory computer readable medium including instructions that, when executed by at least one processor, cause the at least one processor to perform operations for establishing a secure connection between resources in separated networks, the operations comprising:
engaging in a control session between a tunneling control service located in a first network and a tunneling control agent located in a second network;
identifying a request, from a requesting resource in the first network, to establish a secure remote connection with a target resource in the second network, the target resource having a network address in the second network;
sending, over the control session, from the tunneling control service in the first network to the tunneling control agent in the second network, a prompt to establish a reverse tunnel between the first network and the second network, wherein the sent prompt prompts the tunneling control agent to initialize a tunneling agent at the second network;
transmitting a request for a reverse tunnel connection between a tunneling server in the first network and the tunneling agent in the second network, the tunneling agent being configured to redirect received traffic from the reverse tunnel to the target resource at the network address in the second network; and
transmitting data traffic from the requesting resource in the first network through the reverse tunnel to the tunneling agent, for redirection by the tunneling agent to the target resource.

2. The non-transitory computer readable medium of claim 1, wherein the network address is unknown by and inaccessible to the requesting resource.

3. The non-transitory computer readable medium of claim 1, wherein the prompt to establish the reverse tunnel between the first network and the second network is sent over the control session.

4. The non-transitory computer readable medium of claim 1, wherein the tunneling agent is an instance that is generated on demand by the tunneling control agent.

5. The non-transitory computer readable medium of claim 1, wherein the operations further comprise receiving, from the tunneling agent, a specified port number associated with the target resource.

6. The non-transitory computer readable medium of claim 5, wherein the transmitting of data traffic from the requesting resource in the first network through the reverse tunnel to the tunneling agent includes identifying the specified port number for the target resource.

7. The non-transitory computer readable medium of claim 5, wherein the transmitting of data traffic from the requesting resource in the first network through the reverse tunnel to the tunneling agent includes concatenating an IP address of the tunneling agent with the specified port number for the target resource.

8. The non-transitory computer readable medium of claim 5, wherein the specified port number is unique to the reverse tunnel.

9. The non-transitory computer readable medium of claim 5, wherein the specified port number is dynamically allocated by the tunneling agent in response to the request for the reverse tunnel connection.

10. The non-transitory computer readable medium of claim 1, wherein the reverse tunnel is transparent to the target resource.

11. The non-transitory computer readable medium of claim 1, wherein the operations further comprise terminating the reverse tunnel upon conclusion of the secure remote connection with the target resource.

12. The non-transitory computer readable medium of claim 1, wherein the tunneling control service located in the first network is configured to communicate with a plurality of different tunneling control agents located in a plurality of different networks.

13. The non-transitory computer readable medium of claim 1, wherein the requesting resource has a software agent running locally on the requesting resource, the software agent being configured to monitor data traffic from the requesting resource and intercept data traffic that is destined for the target resource.

14. The non-transitory computer readable medium of claim 13, wherein the software agent is further configured to:
determine that the reverse tunnel has been established between the tunneling server in the first network and the tunneling agent in the second network;
determine a specified port number associated with the target resource; and
redirect the data traffic from the requesting resource to the target resource via the reverse tunnel.

15. The non-transitory computer readable medium of claim 13, wherein the software agent is configured to:
determine that no reverse tunnel is currently established between the tunneling server in the first network and the tunneling agent in the second network;
send a request to the tunneling control agent to establish a reverse tunnel;
determine a specified port number associated with the target resource; and
redirect the data traffic from the requesting resource to the target resource via the reverse tunnel.

16. A computer-implemented method for establishing a secure connection between resources in separated networks, the method comprising:
engaging in a control session between a tunneling control service located in a first network and a tunneling control agent located in a second network;
identifying a request, from a requesting resource in the first network, to establish a secure remote connection with a target resource in the second network, the target resource having a network address in the second network;
sending, over the control session, from the tunneling control service in the first network to the tunneling control agent in the second network, a prompt to establish a reverse tunnel between the first network and the second network, wherein the sent prompt prompts the tunneling control agent to initialize a tunneling agent at the second network;
transmitting a request for a reverse tunnel connection between a tunneling server in the first network and the tunneling agent in the second network, the tunneling agent being configured to redirect received traffic from the reverse tunnel to the target resource at the network address in the second network; and
transmitting data traffic from the requesting resource in the first network through the reverse tunnel to the tunneling agent, for redirection by the tunneling agent to the target resource.

17. The computer-implemented method of claim 16, wherein the tunneling control agent and tunneling agent are a single integrated resource.

18. The computer-implemented method of claim 16, wherein at the time of identifying the prompt to establish the secure remote connection with the target resource in the second network, the target resource has not yet been instantiated.

19. The computer-implemented method of claim 18, further comprising instantiating the target resource as a virtual machine instance.

20. The computer-implemented method of claim 18, further comprising instantiating the target resource as a container instance.

21. The computer-implemented method of claim 16, further comprising establishing a plurality of reverse tunnels between the tunneling server in the first network and a plurality of tunneling agents in the second network, each of the plurality of tunneling agents being configured to redirect traffic from their respective reverse tunnel to different target resources in the second network.

22. The computer-implemented method of claim 21, wherein each respective reverse tunnel has a different port number, and each port number is provided to the tunneling server.

23. The computer-implemented method of claim 16, wherein the network address is specified by the requesting resource in the prompt to establish the secure remote connection with the target resource.

24. The computer-implemented method of claim 16, wherein the prompt to establish the reverse tunnel between the first network and the second network is sent over the control session. 7
